(19) United States
(12) Patent Application Publication
(10) Pub. No.: US 2014/0192658 A1
(43) Pub. Date: Jul. 10, 2014

(54) Dynamic selection of positioning system and display map

(71) Applicant: QUALCOMM INCORPORATED, San Diego, CA (US)

(72) Inventors: Sai Pradeep Venkatraman, Santa Clara, CA (US); Weihua Gao, San Jose, CA (US); Gengsheng Zhang, Cupertino, CA (US)

(73) Assignee: QUALCOMM Incorporated, San Diego, CA (US)

(21) Appl. No.: 13/734,733

(22) Filed: Jan. 4, 2013

(51) Int. Cl. H04W 4/02

(52) U.S. Cl. CPC H04W 4/025
USPC 370/252; 370/338

(57) ABSTRACT

Systems, apparatus and methods for determining whether to use an indoor map or an outdoor map based on local area network (LAN) signals from access points (APs) are disclosed. If only weak AP signals belonging to a location content identifier (LCI) are received, prior art systems display an indoor map associated with the LCI. An improvement herein further determines a quality of AP signals and/or wide area network (WAN) signals before determining whether to display the indoor map or an outdoor map.

### CROSS-REFERENCE TO RELATED APPLICATIONS

This is the first application filed for the present technology

### BACKGROUND

I. Field of the Invention

This disclosure relates generally to systems, apparatus and methods for position estimation, and more particularly to selection and display of an appropriate indoor or outdoor map based on access point signals.

II. Background

An overhead map of an indoor or pedestrian area shows a map of walls, paths, hallways, barriers, passage ways and the like. The overhead map may be of a distinguishable logical section of a building (e.g., an entire floor or single wing) may be referred to as location content. The location content may be indexed or referred to at a location context identifier (LCI). A first LCI may index an entire floor of a particular building. A second LCI may index a second floor of the particular building. A set of LCIs may index various wings of a different building. Therefore, some buildings have a single LCI indexing a single floor plan while other buildings have multiple LCIs each corresponding to a different logical part the building. Other buildings have no LCI index to a floor plan.

A database may identify whether or not a particular LAN access point (AP) is associated with a particular LCI. This is, a database may indicate associate an AP to an LCI. For example, assume a first floor of a building, containing a number of APs, is associated by a single LCI. In the database, each of the APs on the first floor of the building would be associated with the LCI. A database query may be made to lookup which APs belonging to a particular LCI. Another database query may be made to lookup which LCI is (partially) covered by a particular AP. If an LCI contains an AP, the AP may be referred to as an enabled AP.

In one particular example, a database is found in a map server directory that associates such a rough location with a LCI. Such an LCI may be associated with a locally defined area such as, for example, a particular floor of a building or other indoor area which is not mapped according to a global coordinate system. The map server directory may forward a universal resource indicator (URI) address to a particular map server from which a local digital map may be retrieved (e.g., according to HTTP). In one example, such a URI may include an embedded LCI associated with the rough location of the mobile device 100 determined based, at least in part, on information transmitted.

In one particular implementation, a request for indoor navigation assistance data from the mobile device 100 may specify a location context identifier (LCI). Such an LCI may be associated with a locally defined area such as, for example, a particular floor of a building or other indoor area which is not mapped according to a global coordinate system. In one example, upon entry of an area, the mobile device 100 may request a first server provides one or more LCIs covering the area and/or adjacent areas. Here, the request from the mobile device 100 may include a rough location of the mobile device 100 such that the requested server may associate the rough location with areas covered by known LCIs, and then transmit those LCIs to the mobile device 100. The mobile device 100 may then use the received LCIs in subsequent messages with a different server, such as server 150, for obtaining navigation assistance data relevant to an area identifiable by one or more of the LCIs as discussed above (e.g., digital maps, locations and identifies of beacon transmitters, radio heat maps or routeability graphs).

In one particular implementation, a request for indoor navigation assistance data from the mobile device 100 may specify a location context identifier (LCI). Such an LCI may be associated with a locally defined area such as, for example, a particular floor of a building or other indoor area which is not mapped according to a global coordinate system. In one example server architecture, upon entry of an area, the mobile device 100 may request a first server, such as server 140, to provide one or more LCIs covering the area or adjacent areas. Here, the request from the mobile device 100 may include a rough location of the mobile device 100 such that the requested server may associate the rough location with areas covered by known LCIs, and then transmit those LCIs to the mobile device 100. The mobile device 100 may then use the received LCIs in subsequent messages with a different server, such as server 150, for obtaining navigation assistance data relevant to an area identifiable by one or more of the LCIs as discussed above (e.g., digital maps, locations and identifies of beacon transmitters, radio heat maps or routeability graphs).

In many cases, a particular LCI is associated with a number of APs. A mobile device 100 scans for one or more APs, and then searches the AP database to determine whether the mobile device 100 is within one of the known indoor areas defined by the LCI. In some circumstances, APs may be found from different LCIs. In these circumstances, the best LCI (e.g., having an AP with the strongest RSSI or the shortest RTT) may be selected. Conventionally, if a mobile device 100 detects multiple APs belonging to different LCIs, then the best LCI from the possible LCIs is selected to hold the mobile device 100. That is, a mobile device 100 is coupled to or tied to be within an LCI if that LCI contains the best AP signal (e.g., strongest RSSI or shortest RTT).

What is needed is a way to untie the mobile device from an enabled AP when one or more APs associated with one or more LCIs are detected but all providing a substandard signal (e.g., a low RSSI or a long RTT).

### BRIEF SUMMARY

Systems, apparatus and methods for determining whether to use an indoor map or an outdoor map based on signals from access points (APs) are disclosed. If only weak AP signals belonging to a location content identifier (LCI) are received, prior art systems display an indoor map associated with the LCI. An improvement herein further determines a quality of AP signals before determining whether to display the indoor map or an outdoor map.

According to some aspects, disclosed is a method in a mobile device for determining a map to be used based on signals from access points (APs), the method comprising: scanning signals from a plurality of APs, wherein the plurality of APs comprise a first set of APs belonging to a location context identifier (LCI) wherein the LCI comprises an indoor map; selecting the first set of APs from the plurality of APs belonging to the LCI; performing a threshold test to determine that the first set of APs comprises only APs beyond a threshold; and displaying an outdoor map with a position estimate of the mobile device based on the first set of APs comprising only APs beyond the threshold belonging to the LCI.

According to some aspects, disclosed is a mobile device for determining a map to be used based on signals from access points (APs), the device comprising: a transceiver configured to scan signals from a plurality of APs, wherein the plurality of APs comprise a first set of APs belonging to a location context identifier (LCI) wherein the LCI comprises an indoor map; a selection unit coupled to the transceiver, the selection unit configured to select the first set of APs from the plurality of APs belonging to the LCI; a comparator coupled to the selection unit and a threshold, the comparator configured to determine the first set of APs comprises only APs beyond a threshold; and a display coupled to the comparator, the indoor map and an outdoor map, the display configured to display the outdoor map with a position estimate of the mobile device based on the first set of APs comprising only APs beyond the threshold belonging to the LCI.

According to some aspects, disclosed is a mobile device for determining a map to be used based on signals from access points (APs), the device comprising: means for scanning signals from a plurality of APs, wherein the plurality of APs comprise a first set of APs belonging to a location context identifier (LCI) wherein the LCI comprises an indoor map; means for selecting the first set of APs from the plurality of APs belonging to the LCI; means for performing a threshold test to determine that the first set of APs comprises only APs beyond a threshold; and means for displaying an outdoor map with a position estimate of the mobile device based on the first set of APs comprising only APs beyond the threshold belonging to the LCI.

According to some aspects, disclosed is a device comprising a processor and a memory for determining a map to be used based on signals from access points (APs) wherein the memory includes software instructions for: scanning signals from a plurality of APs, wherein the plurality of APs comprise a first set of APs belonging to a location context identifier (LCI) wherein the LCI comprises an indoor map; selecting the first set of APs from the plurality of APs belonging to the LCI; performing a threshold test to determine that the first set of APs comprises only APs beyond a threshold; and displaying an outdoor map with a position estimate of the mobile device based on the first set of APs comprising only APs beyond the threshold belonging to the LCI.

According to some aspects, disclosed is a non-volatile computer-readable storage medium including program code stored thereon, comprising program code for: scanning signals from a plurality of APs, wherein the plurality of APs comprise a first set of APs belonging to a location context identifier (LCI) wherein the LCI comprises an indoor map; selecting the first set of APs from the plurality of APs belonging to the LCI; performing a threshold test to determine that the first set of APs comprises only APs beyond a threshold; and displaying an outdoor map with a position estimate of the mobile device based on the first set of APs comprising only APs beyond the threshold belonging to the LCI.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIGS. 1 and 2 show a user's true position within range of multiple access points but positioned outside of buildings.

FIGS. 3-8 illustrate methods to determine a correct map to display, in accordance with some embodiments of the present invention.

FIGS. 9 and 10 show tables of access point information.

FIGS. 11-13 illustrate uncertainty areas associated with position estimates from various sources, in accordance with some embodiments of the present invention.

FIGS. 14-16 illustrate methods to determine a position estimate, in accordance with some embodiments of the present invention.

FIGS. 17 and 18 show two different maps to display depending on possible position location signals.

FIG. 19 shows a method in a mobile device for determining a map to be used based on signals from APs, in accordance with some embodiments of the present invention.

FIGS. 20 and 21 display a method in a mobile device to determine a map to be used based on signals from APs, in accordance with some embodiments of the present invention.

FIG. 22 shows a mobile device, in accordance with some embodiments of the present invention.

FIG. 23 shows a table illustrating whether an indoor map or an outdoor map is displayed, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device 100, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

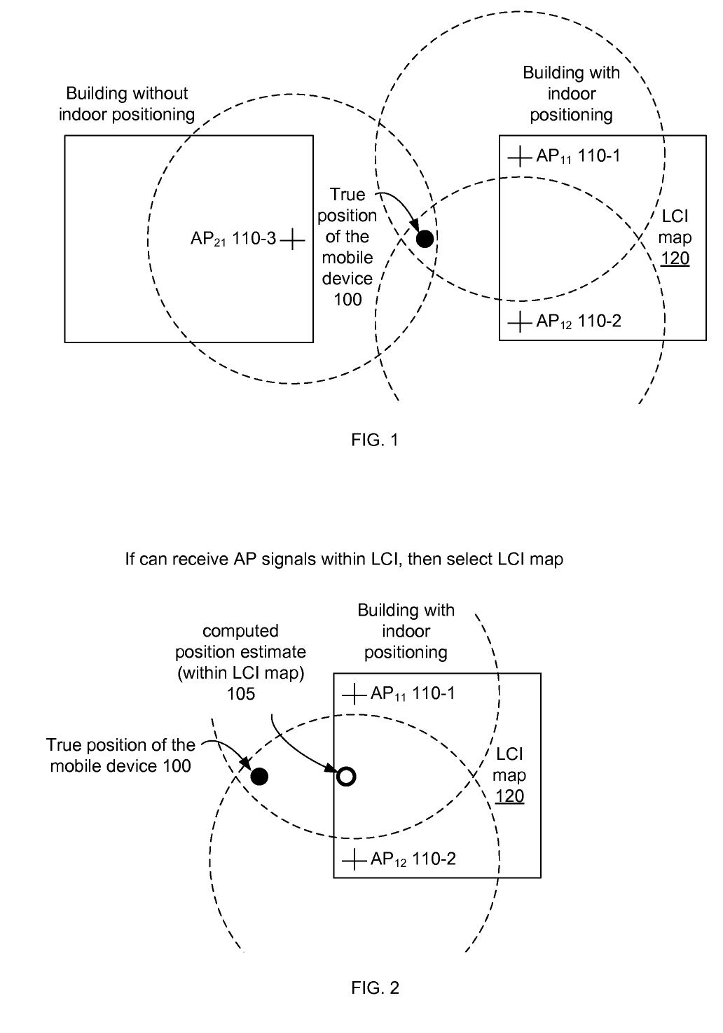

FIGS. 1 and 2 show a user's true position within range of multiple access points (APs) but positioned outside of buildings. In FIG. 1, a true position of a mobile device 100 that is outside of any LCI area is shown. The LCI area is kept by a database and may be, for example, a floor plan of a first floor. The LCI database includes an LCI map 120, which includes features such as hallways, room partitions, conference rooms, offices, bathrooms, common areas, lunch rooms, stairs and/or elevators. The LCI database also includes information about the access points (e.g., AP₁₁ 110-1 and AP₁₂ 110-2 in a first building) indexed by the LCI. This information includes the location of the access points (e.g., latitude/longitude, latitude/longitude/altitude and/or (x, y) from a reference point) and possibly a current transmission mode, transmission levels, and/or the like.

In this case, an LCI database includes LCI information (e.g., detailed floor plan) and AP information (e.g., location of the APs, RTT heat map and/or an RSSI heat map) for the two access points (i.e., AP₁₁ 110-1 & AP₁₂ 110-2). The LCI information and AP information is preprocessed into assistance data and is sent as an assistance data message to the mobile device 100. This particular example, the LCI information indexes location content for two APs, including indoor-positioning information. The LCI information may be referred to as an indoor position-enabled LCI or simply as an enabled LCI. That is, if we have collected and assembled such assistance data related information about a particular LCI, the LCI may be considered an enabled LCI.

Shown is a second building, in which we have not collected and have not assembled such assistance data related information, is considered a disabled LCI. The second building is shown to include AP₂₁ 110-3. Little or no information is known about this access point and this LCI area. This second building may be referred to as an indoor position-disabled LCI or conveniently as a disabled LCI. In summary, an area may be referred to as a disabled LCI if LCI information and AP information is unavailable for the LCI.

FIG. 2 shows a position estimate 105 of a conventional the mobile device 100. A mobile device 100 that receives any signal from an AP in an indoor-position enabled LCI conventionally constrains position fixes to be within the LCI area as shown by position estimate 105. That is, if a mobile device 100 receives AP signals from an AP belonging to particular LCI, then the mobile device 100 is considered to be within that particular LCI at position estimate 105 even if the true position of the mobile device 100 is outside of the LCI. If AP signals are received from access points from multiple enabled LCI, the LCI with the best ranging parameters is selected. The best ranging parameters may be a conglomeration of APs from an LCI that provides the shortest RTT, the strongest RSSI, a combination of both RTT and RSSI, or the like.

Therefore, if a mobile device 100 receives only weak positioning signals (e.g., with RSSI values under a threshold) from one or more enabled LCIs, the mobile device 100 is constrained to be within the best enabled LCI. The best enabled LCI is determined during disambiguation if more than one enabled LCIs is found. This selection is a problem whenever the mobile device 100 has a true position that is not actually within the borders of the best enabled LCI. The positioning system, unfortunately, interprets an outdoor position fix nearby an enabled LCI as being shifted to fall within the LCI map 120 (i.e., within the building defined by the LCI map 120).

Generally, good local signals are viewed from a local area network (LAN) such as an access points, femtocells or picocells, referred to as APs. If no good LAN signals are available from APs, then wide area network (WAN) signals are considered. WAN signals may be WiMAX (Worldwide Interoperability for Microwave Access), cellular or GNSS signals. If no good WAN signals are available, LAN signals are used in a LAN database.

Some embodiments disclosed herein are free from this erroneous constraint of an outdoor position fix being interpreted as and shifted to an indoor position fix when poor enabled APs and no strong enabled APs are available. That is, an LCI map 120 (e.g., indoor floor plan map) is used if good LAN AP signals are available from one or more APs from one or more enabled LCIs. If no good LAN AP signals are received from any AP within an enabled LCI, an outdoor map is used if either good WAN signals (such as good GNSS signals) are available or an urban LAN database (such as an urban WiFi database) provides a position fix.

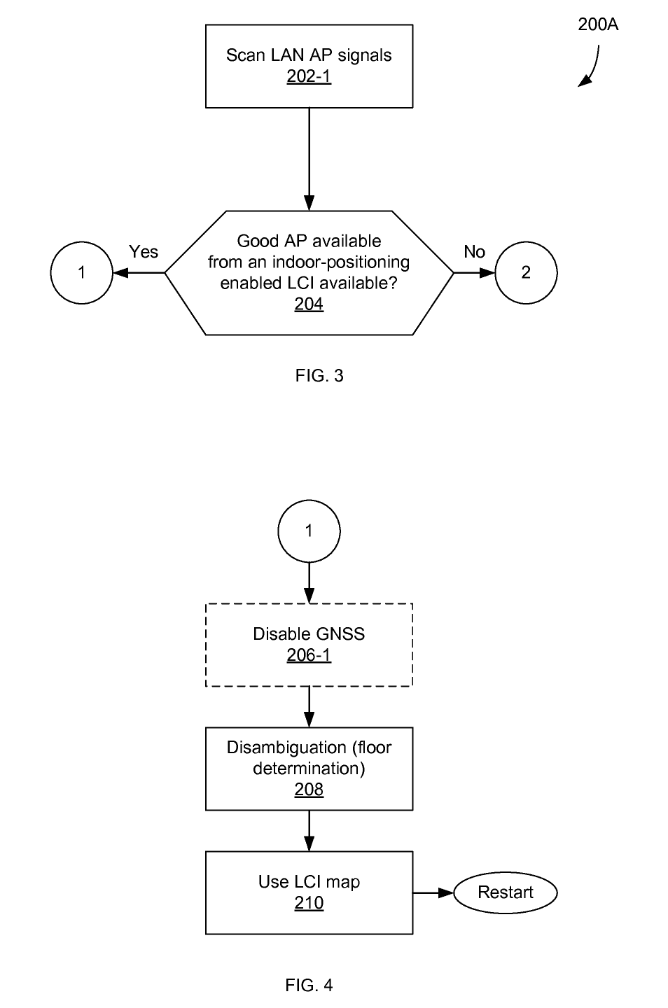

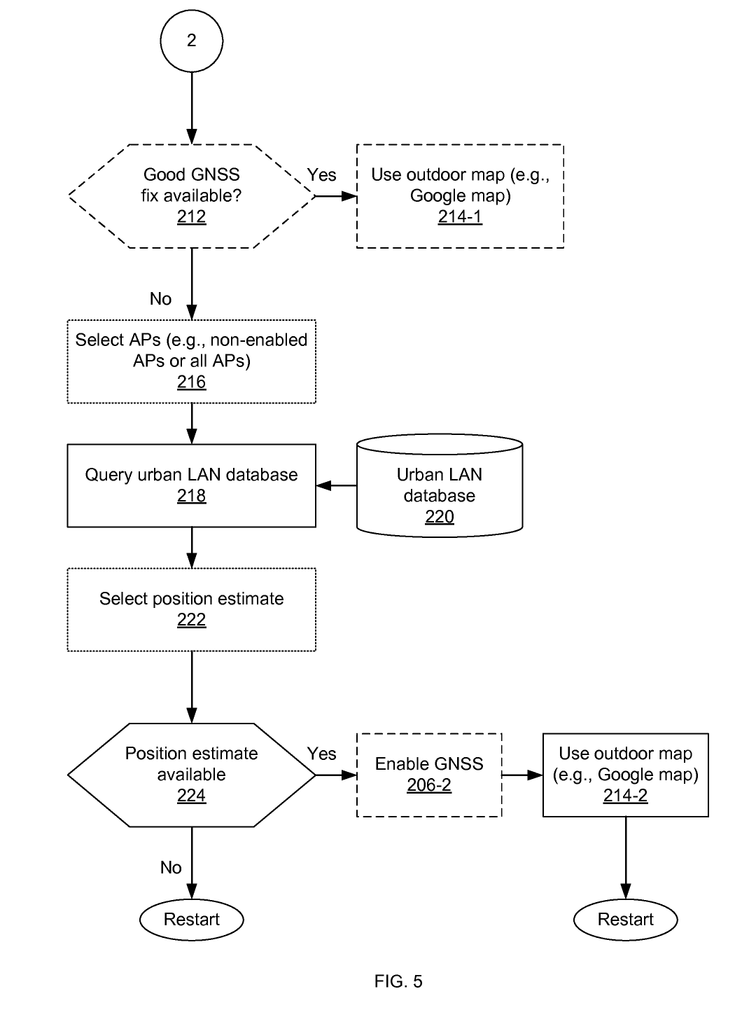

FIGS. 3-8 illustrate methods to determine a correct map to display, in accordance with some embodiments of the present invention. In FIG. 3, a method 200A to determine a correct map to display is shown. The method begins at 202-1, where a mobile device 100 scans for an available local area network (e.g., access points, femtocells, and/or picocells) to detect LAN AP signals (e.g., WiFi signals). The method creates a scan list listing APs. At 204, a test checks whether one or more APs from indoor-positioning enabled LCIs (referred to here as enabled LCIs) with a good signal are detected. An AP signal is good if the signal passes a threshold test. For example, RSSI values are good if they are stronger than a threshold level. RTT values are good if they are less than a threshold time. The scan list may be updated to reflect if an AP signal is from an enabled LCI or disassociated from an LCI. At continuation circle 1, if good signals from APs in an enabled LCI are detected, method 200A continues at 206-1 in FIG. 4. At continuation circle 2, if no good signals from an AP in an enabled LCI are received, method 200A continues at 212 if FIG. 5.

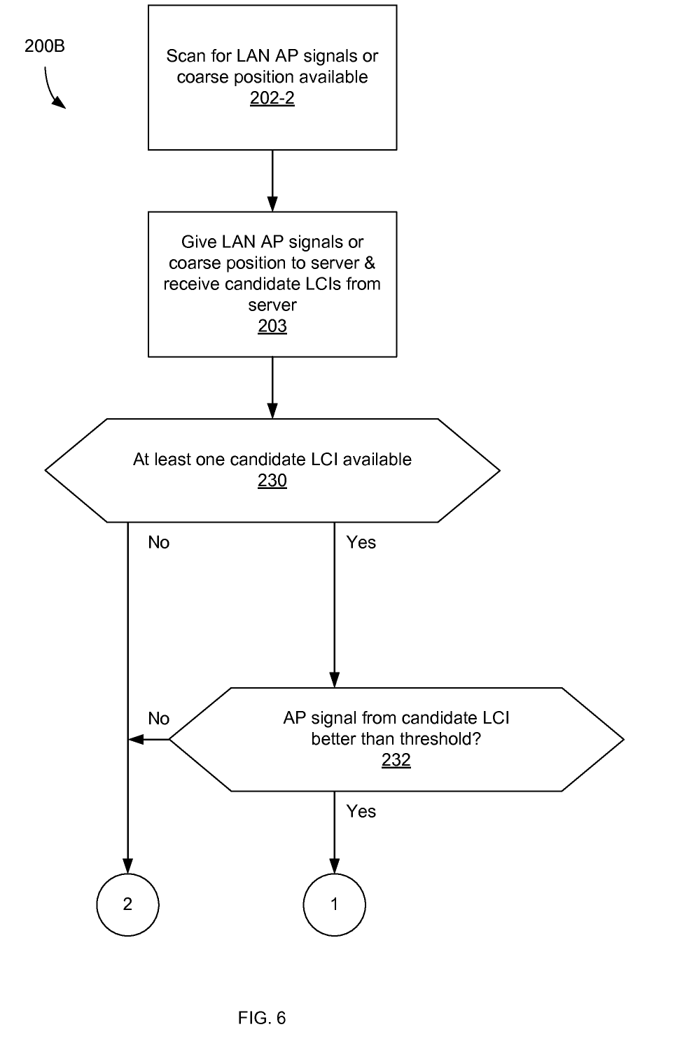

FIG. 4 begins at continuation circle 1 from FIGS. 3 and 6. In FIG. 4 at 206-1, GNSS circuitry is optionally disabled to save power. If more than one enabled LCI exists, at 208, disambiguation is performed to determine which LCI is the best LCI from the multiple enabled LCIs. At 210, an LCI map 120 associated with the best LCI is displayed in detail. The method may end or restart at 202.

FIG. 5 begins at continuation circle 2 from FIGS. 3 and 6. With devices having a GNSS receiver (shown with dotted lines), the method begins at 212. In FIG. 5, at 212, a determination is made as to whether a good GNSS fix is available. If a good GNSS fix is available, method 200A continues to 214-1, which displays an outdoor map (e.g., a Google street, aerial or satellite map). If no good GNSS fix is available, method 200A continues to 216. As previously mentioned, some devices do not contain a GNSS receiver, or alternatively, the GNSS receiver is disabled. In these cases, 212 and 214-1 are skipped and FIG. 5 begins at 216, as indicated by the dotted boxes.

Next at 216, a selection of APs is made from the scan list of APs to result in a set of APs. The selection may be all APs from disabled LCIs (i.e., APs not associated with any LCI). The selection may be all APs. The selection may be APs that pass a threshold test (e.g., AP with the highest RSSI or lowest RTT values as compared to a threshold). The selection may be APs from the top of a list, for example, N number of APs (e.g., passing a threshold test). The selection may be all enabled APs. Alternatively, two or more sets of APs may be selected from the sets described above.

At 218, an urban LAN database 220 is accessed with the selected set(s) of APs to determine a position estimate. This query may be made once with various sets if APs: (1) all available AP; (2) APs from the disabled LCIs (i.e., APs not associated with any LCI); (3) APs from the enabled LCIs (i.e., APs associated with a known LCI); (4) the strongest APs (e.g., based on RSSI); and/or (5) the nearest APs (e.g., based on RTT).

At 222, if multiple position estimates are found with different sets of APs, a position estimate may be selected or determined from the multiple position estimates. At 224, a test is performed to determine if a fix is determined with a high enough certainty. If no position estimate is available, the method ends and may restart at 202-1. If a position estimate is available, at 206-2, GNSS circuitry may optionally be disabled, as indicated by the dotted boxes. At 214-2, an outdoor map is used. The method may end and restart at 202-1.

FIG. 6 begins another example of method 200B. As described above, method 200B begins at 202-2. At 202-2, a scan of LAN AP signals is performed to populate a scan list. Alternatively, a coarse position is obtained. At 203, a mobile device 100 provides in a request including the scan list to a server and, in response, the server returns a candidate list of LCIs. Alternatively, the mobile device 100 provides in the coarse position to the server and, in response, the server returns the candidate list of LCIs. At 230, a decision is made as to whether at least one candidate LCI is available. If no candidate LCI is available, method 200B continues to circle 2 described above and shown in FIG. 5. If at least one candidate LCI is available, method 200B continues to 232, which determines whether at least one AP signal from a candidate LCI is better than a threshold. If so, method 200B continues to circle 1 described above and shown in FIG. 4. If not, method 200B continues to circle 2 also described above with reference to FIG. 5.

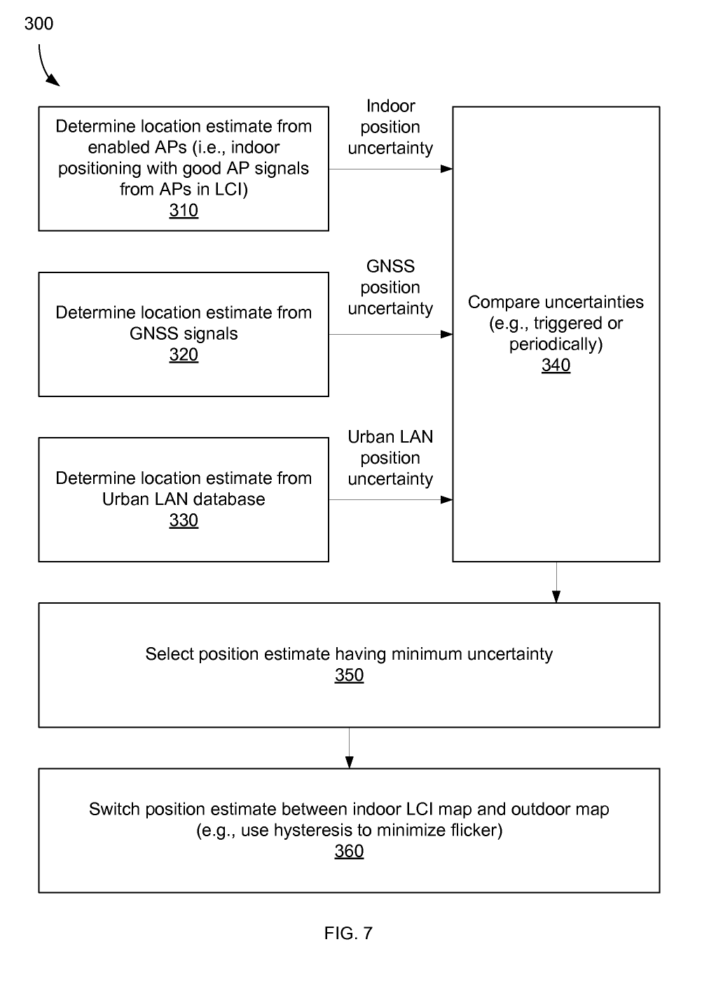

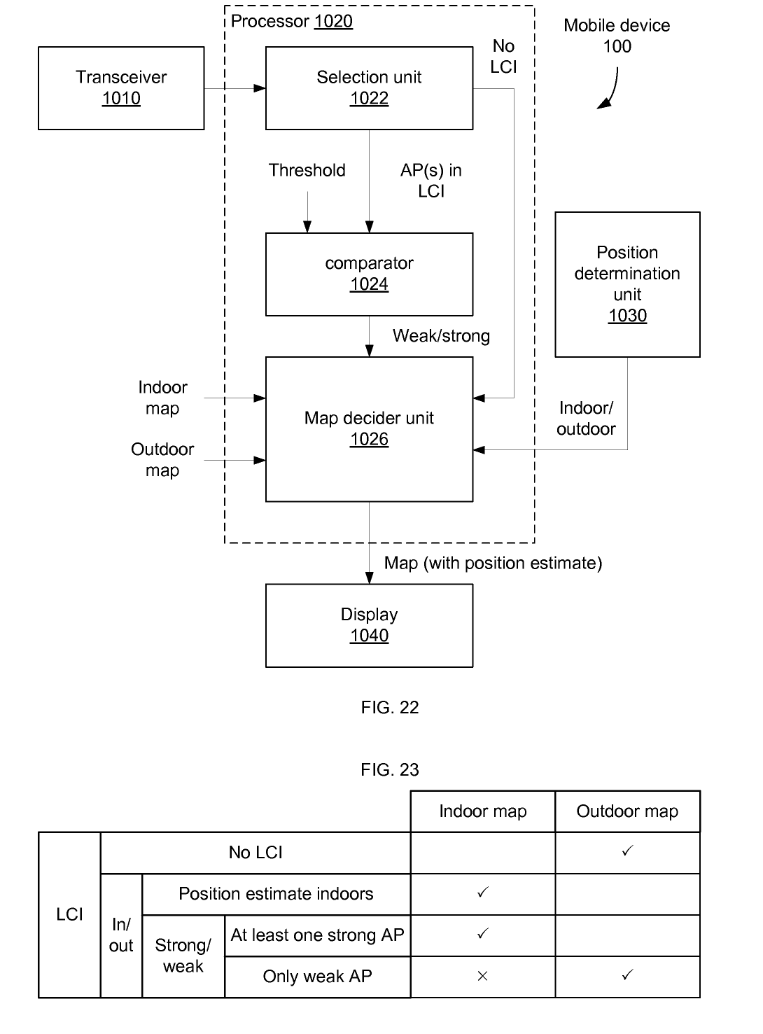

In FIG. 7, a method 300 is disclosed to toggle between indoor and outdoor maps. At 310, a processor (e.g., processor 1020 of FIG. 22) determines a location estimate from enabled APs (e.g., determining indoor positioning with good AP signals from APs in an LCI). The location estimate, if available, usually comprises an indoor position with a corresponding uncertainty. The processor may determine a mobile device 100 is at a location relative to APs in the LCI at a fixed distance from each AP. For example, the processor may determine that the mobile device 100 is 20 meters from a first AP, 40 meters from a second AP and 60 meters from a third AP. If the locations of the APs are known either relative to each other or absolutely, the processor may compute the location of the mobile device 100 in a local reference system (e.g., relative to a reference point at (x, y)=(0,0)) or absolutely (e.g., in terms of latitude and longitude).

At 320, a processor determines a location estimate from GNSS signals. The location estimate, if available, usually comprises latitude and longitude of an outdoor position with a corresponding uncertainty. Often the uncertainty is a function of the number of acceptable GNSS satellites as well as their spread. The position may be at an indoor location with an ability to receive GNSS signals, for example, near a window or outside door.

At 330, a processor determines a location estimate from an urban LAN database 220. First, the processor scans for and finds various APs, independent of any LCI. Next, a database is polled with a set of found AP. The set of found APs may include all APs found. The set of found APs may include only APs that belong to no LCI. Alternatively, the set of APs may include only APs that belong to some LCI. Again, the location estimate, if available, usually comprises latitude and longitude of an outdoor or indoor position with a corresponding uncertainty.

To compute the various position estimates, steps 310, 320 and 330 are performed in parallel, serially or a combination of both by one, two or three separate processors. The various position estimates may be pushed or polled synchronously, asynchronously, periodically, aperiodically, or may be triggered by an event. At 340, a processor compares the uncertainties and at 350 either selects the one position estimate having the lowest uncertainty or computes a position estimate base on two or three position estimates and/or their uncertainties.

At 360, the processor switches or toggles between position estimate between an indoor LCI map 120 and outdoor map (e.g., satellite or overhead map) use hysteresis to minimize flicker. For example, an outdoor map may be displayed first. After receiving an indication of an indoor map for a time or a count greater than a threshold, an indoor map may be displayed. Similarly, an outdoor map may be displayed again after one or several indications (greater than a threshold of time or count).

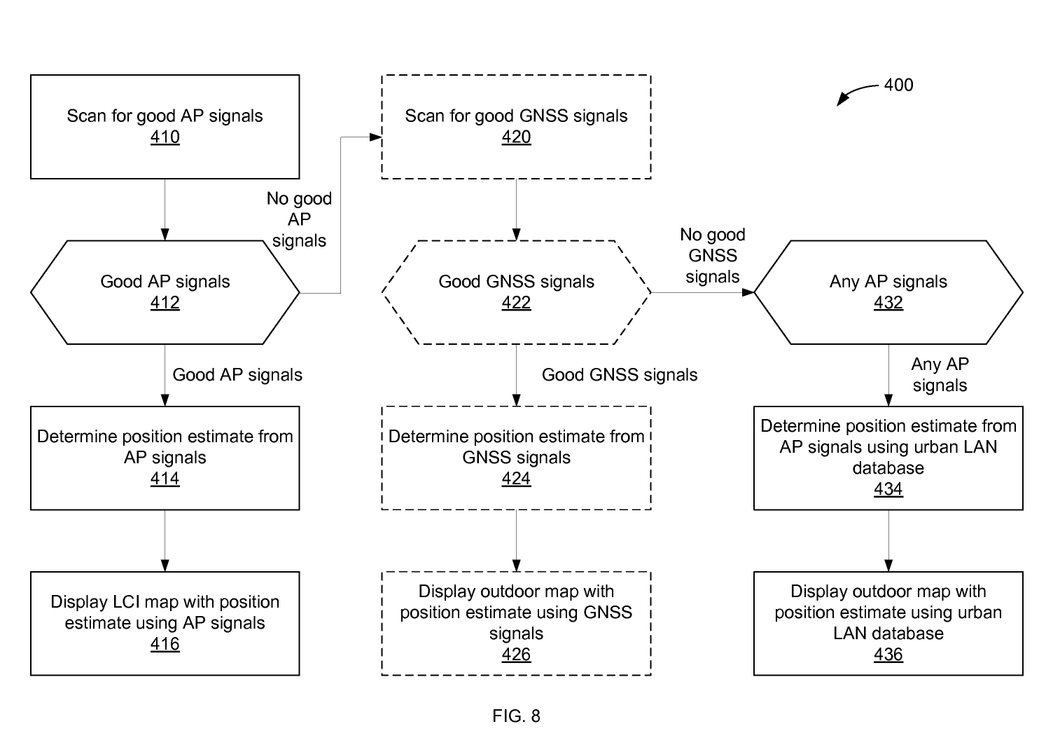

In FIG. 8, another method 400 is disclosed to toggle between indoor and outdoor maps. First, at 410, a processor (e.g., processor 1020 of FIG. 22) scans for one or more good AP signals from APs within an LCI (enabled LCI). At 412, a determination is made whether good AP signals exist. If good AP signals exist, processing continues at 414 and if no good AP signals exist, then processing continues at 420. At 414, if good AP signals from an LCI exist, the processor determines a position estimate from the good AP signals. Next, at 416, the processor displays an LCI map 120 with the position estimate and possibly the position estimate's corresponding uncertainty.

In some embodiments, no GNSS capability exists (e.g., no GPS receiver as indicated by the dotted boxes in the figure) so step 412 proceeds to step 432. In embodiments with a GNSS receiver, at 420, the processor scans for good GNSS signals. At 422, a determination is made whether good GNSS signals exist. If good GNSS signals exist, processing continues at 424 and if no good GNSS signals exist, then processing continues at 432. At 424, the processor determines a position estimate from the GNSS signals. At 426, the processor displays an outdoor map with the determined position estimate and possibly the position estimate's corresponding uncertainty.

At 432, the processor determines if any AP signals were received (e.g., at 410). Assuming that some AP signal is received, processing continues at 434. At 434, a set of AP signals are used with an urban LAN database 220. The set of AP signals may be from all APs detected, from only non-LCI APs, or from only LCI APs. Alternatively, the urban LAN database 220 may be accessed with two or three different sets of APs resulting in two or three position estimates. The processor either selects from the results (e.g., the result with the smallest uncertainty) or combines the results (e.g., resulting in a weighed position estimate). At 436, the processor displays an outdoor map with the position estimate and possibly the position estimate's corresponding uncertainty.

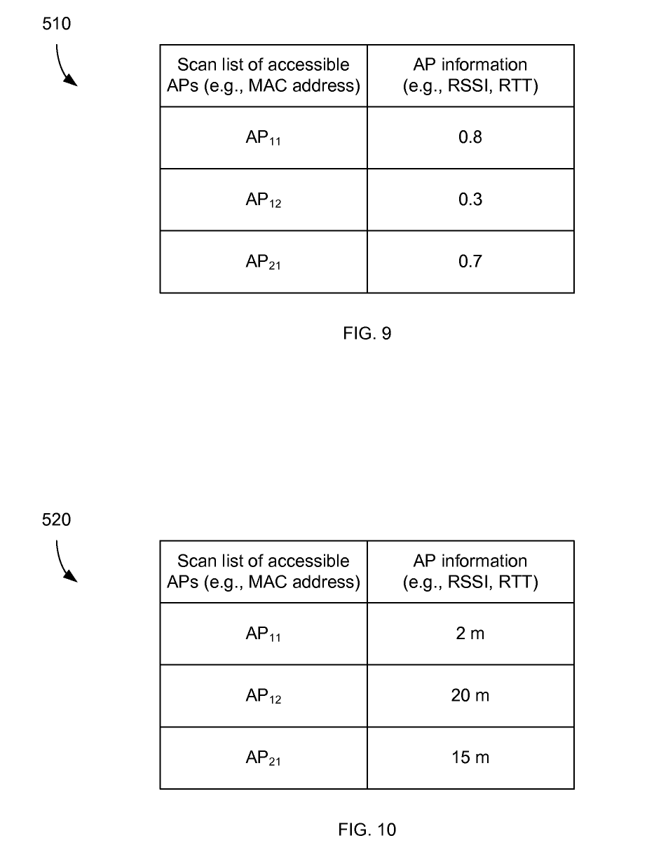

FIGS. 9 and 10 show tables 510 and 520 of access point information. The example tabulated AP information shows information determined by a mobile device 100 and/or a server. AP information may include one or more parameters (e.g., RSSI measurements, RTT measurements, etc.). For example, FIG. 9 shows a scan list 510 including a power parameter of 0.8, 0.3 and 0.7 (e.g., a received signal strength indicator (RSSI) measurements or a round-trip time (RTT) measurement, in absolute or dB units) for each accessible AP (e.g., AP₁₁, AP₁₂ and AP₂₁, respectfully, shown in FIG. 1). A higher power value or a lower time measurement probably represents a closer AP. A power or time measurement may be converted to a distance parameter. FIG. 10 shows a distance table 520 with a distance parameter of 2 m, 20 m and 15 m (e.g., derived from an RTT or an RSSI measurement) to each of three accessible APs (AP₁₁, AP₁₂ and AP₂₁, respectfully).

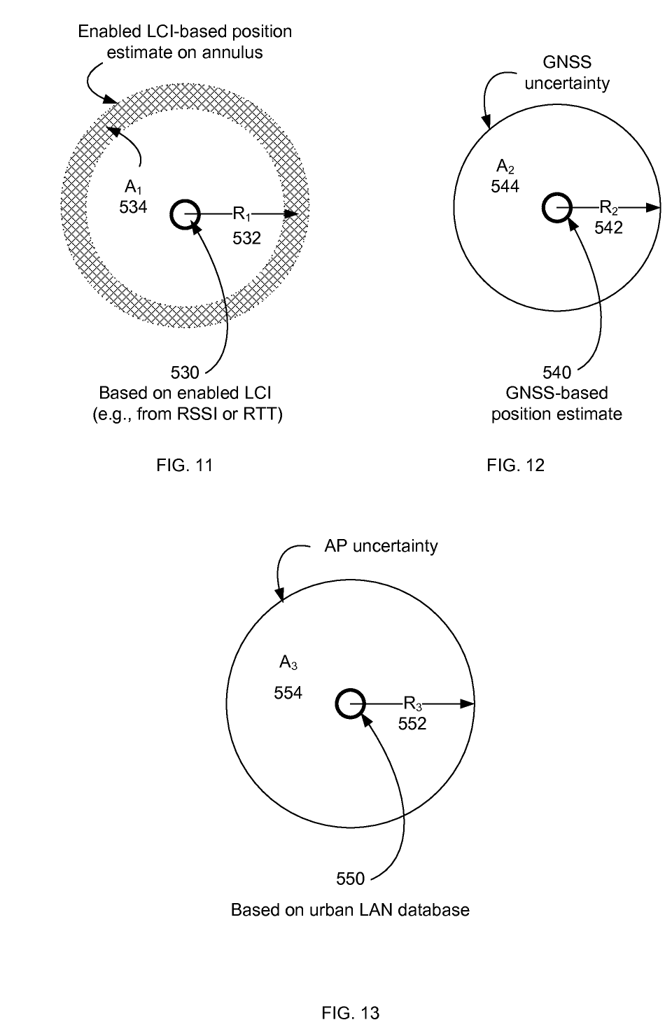

FIGS. 11-13 illustrate uncertainty areas associated with position estimates from various sources, in accordance with some embodiments of the present invention. In FIG. 11, an annulus area A₁ 534 determined from AP positioning using AP signals from an enabled LCI. Usually, this annulus area A₁ 534 having a mean radius R₁ 532 may be known with a higher degree of certainty than found with GNSS or urban LAN positioning. To create an annulus from a mobile device 100, the mobile device 100 scans for and detects an access point with a known location. For example, an RSSI or RTT measurement lead to a distance (R₁ 532 or radius of annulus) having a certain uncertainty (i.e., width of annulus) to form an annulus with area A₁ 534. Without any further information, the center 530 of the annulus may represent a position estimate. Some other information may skew the position estimate from the center of the annulus to on the annulus, as described below with reference to FIG. 16.

In FIG. 12, a GNSS position estimate is shown. A center 540 of the GNSS-based position estimate and a radius R₂ 542 defines an area A₂ 544 representing the GNSS uncertainty. In FIG. 13, a position estimate derived from an urban LAN position estimate is shown. Again a center 550 of the urban LAN-based position estimate and a radius R₃ 552 defines an area A₃ 554 representing the urban LAN-based uncertainty.

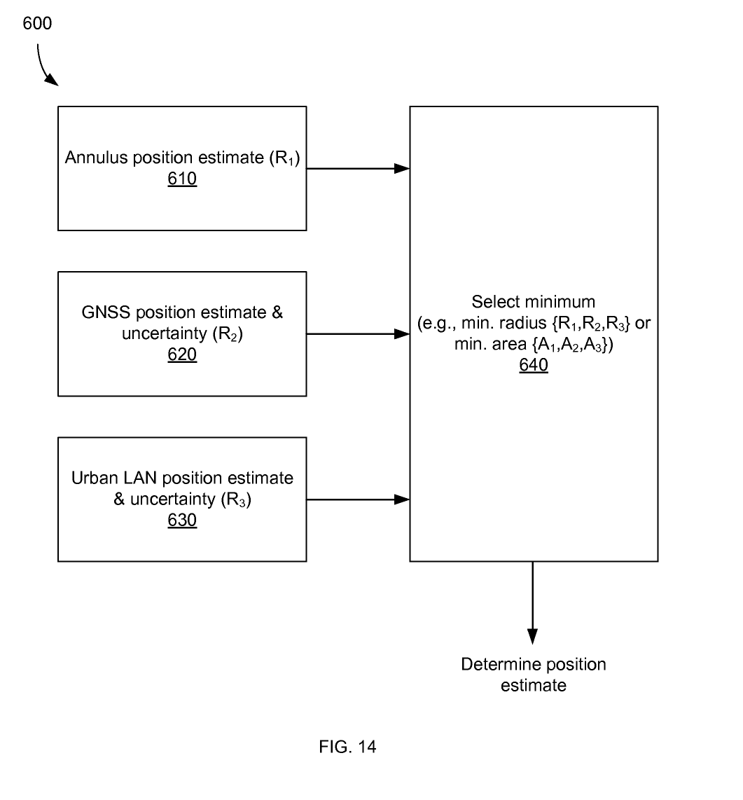

FIGS. 14-16 illustrate methods to determine a position estimate, in accordance with some embodiments of the present invention.

FIG. 14 shows a method 600 for selecting the best position estimate from three positioning methods. At 610, a processor (e.g., processor 1020 of FIG. 22) computes an annulus position estimate and corresponding uncertainty R₁, which defines an uncertainty area A₁. At 620, a processor computes a GNSS-based position estimate and corresponding uncertainty R₂, which defines an uncertainty area A₂. Similarly, at 630, a processor computes an urban LAN-based position estimate and corresponding uncertainty R₃, which defines an uncertainty area A₃. At 640, a processor selects a minimum uncertainty (e.g., an uncertainty having a minimum radius from {R₁, R₂, R₃} or an uncertainty having a minimum area from {A₁, A₂, A₃}) to determine a position estimate. Alternatively, the processor may combine the position estimates based on their various uncertainties. The processor provides the determined position estimate as an output. In some embodiments, the uncertainties are used to select either an indoor map or an outdoor map to display to a user.

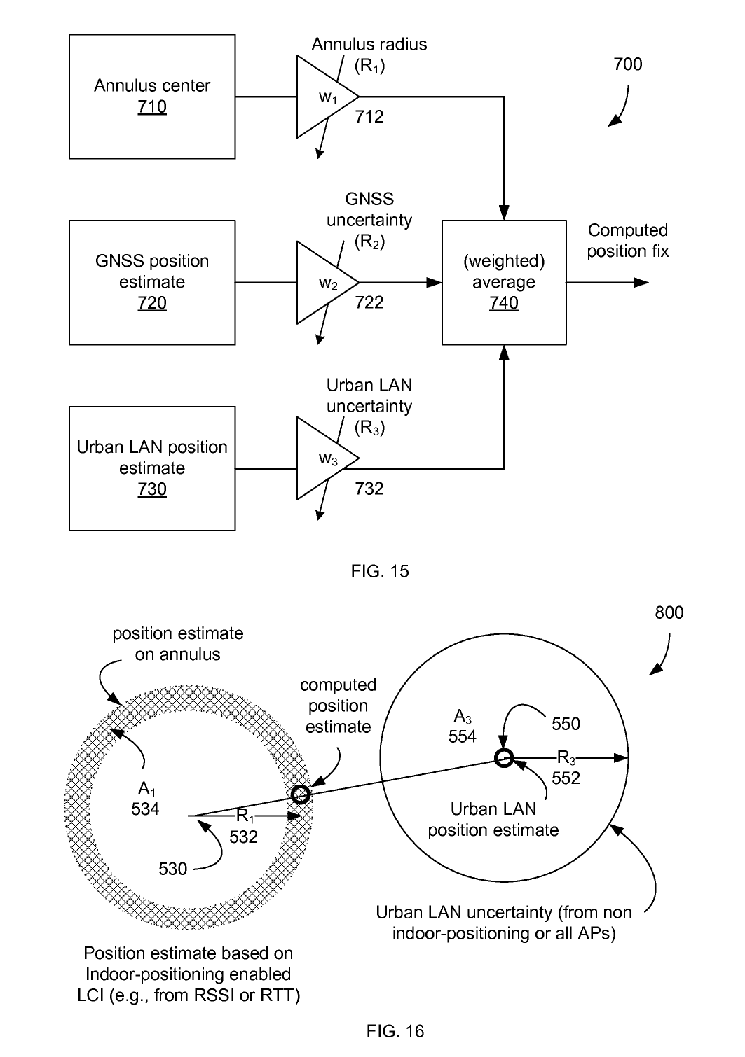

FIG. 15 illustrates a weighted average 700 of three positioning methods. At 710, the center 530 of the annulus is weighted at 712 by w₁ determined by a function of the annulus radius R₁ 532. That is, a high uncertainty provides a low weighting of the position estimate and a low uncertainty provides a high weighting of the position estimate. At 720, the center 540 of the uncertainty is weighted at 722 by w₂ determined by a function of the uncertainty radius R₂ 542. At 730, the center 550 of the uncertainty is weighted at 732 by w₃ determined by a function of the uncertainty radius R₃ 552. At 740, the weighted position estimates are summed to a combined position estimate, which takes into account the original position estimates and their uncertainties.

FIG. 16 shows an annulus area A₁ 534 (with center 530 and radius 532) and an urban LAN position estimate with area A₃ 554 (with center 550 and radius 552) according to another method 800. The annulus area may be determined (based on a RTT signal, a RSSI signal or the like) with an AP of known position. The urban LAN position estimate may be computed from an urban LAN database 220 using scanned APs that are, for example, from all non-LCI APs or from all APs. Assuming the annulus area is known with more certainty, a combined position estimate process is performed. A position estimate is computed at a point in the annulus with a weighing toward the urban LAN position estimate, as shown.

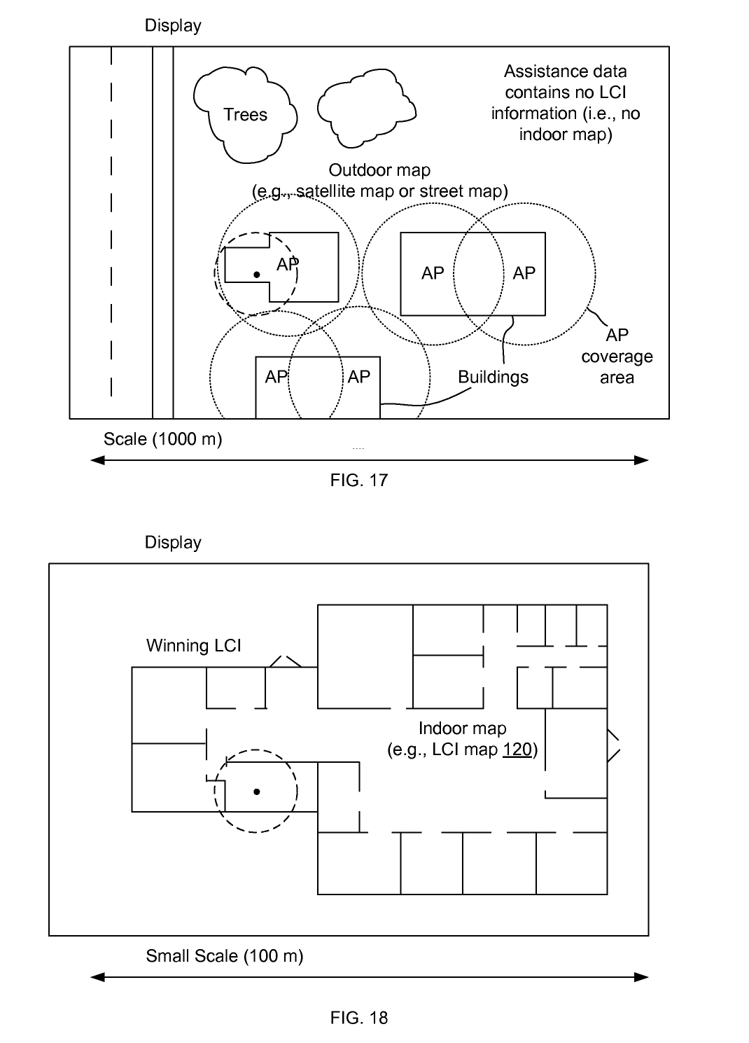

FIGS. 17 and 18 show two different maps to display depending on possible position location signals. FIG. 17 shows an outdoor street map (e.g., from Google maps). In this example, the street map shows a road, sidewalks, trees and outlines of buildings. No LCI information is shown. That is, buildings are not populated with indoor wall maps. Coverage areas and AP locations are optionally shown as overlays onto the outdoor map or indoor map. Even though the positioning method determined the mobile device 100 was within the borders of the building, an outdoor map is used, for example, because the uncertainty is too great or no good AP signals were found from APs belonging to an LCI.

FIG. 18 shows an indoor map including LCI information (referred to as an LCI map 120). The LCI map 120 may include a floor plan of a building. For example, walls, hallways, doorways and open indoor spaces are shown on the indoor map. The position estimate of the mobile device 100 is within the floor plan of the building.

Toggling between an outdoor map (e.g., FIG. 17) and an indoor map (e.g., FIG. 18) may require a hysteresis. That is, before toggling away from an existing map to a new map, a sequence of indications of the new map are needed before switching from the existing map (e.g., an outdoor map) to a new map (e.g., an indoor map).

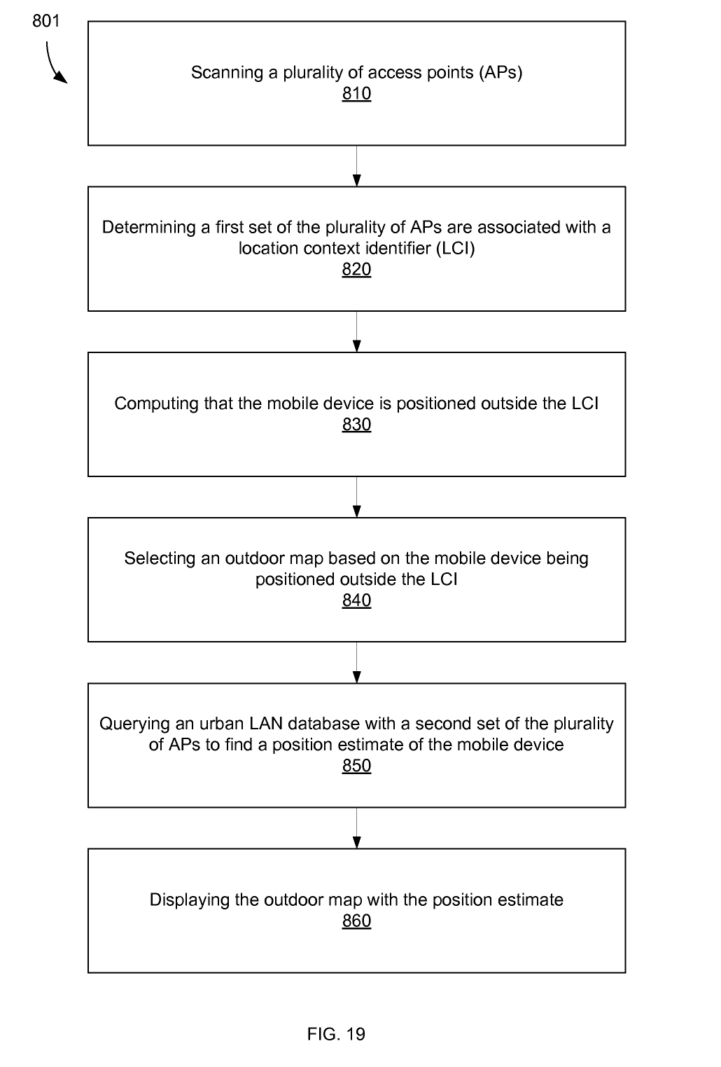

FIG. 19 shows a method 801 in a mobile device 100 for determining a map to be used based on signals from APs, in accordance with some embodiments of the present invention. At 810, a processor (e.g., processor 1020 of FIG. 22) in the mobile device 100 scans a plurality of APs. At 820, the processor determines a first set of the plurality of APs are associated with a location context identifier (LCI). At 830, the processor computing that the mobile device 100 is positioned outside the LCI. At 840, the processor selects an outdoor map based on the mobile device 100 being positioned outside the LCI. At 850, the processor queries an urban LAN database 220 with a second set of the plurality of APs to find a position estimate of the mobile device 100. At 860, the processor displays the outdoor map with the position estimate.

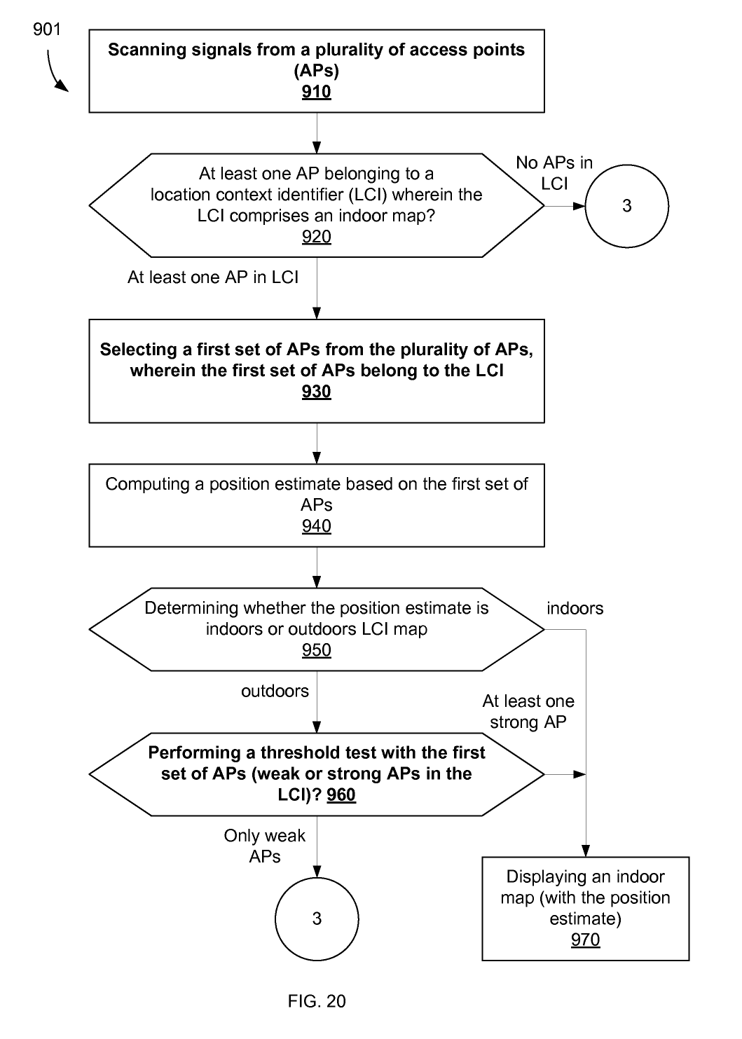

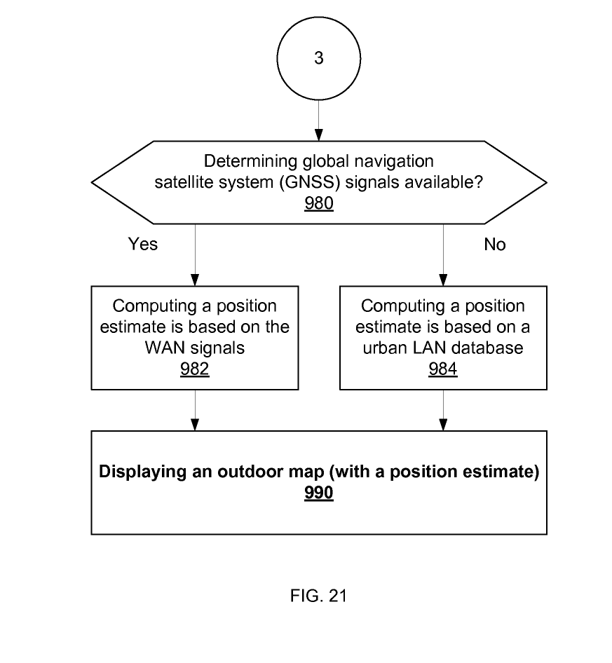

FIGS. 20 and 21 display a method 901 in a mobile device 100 to determine a map to be used based on signals from APs, in accordance with some embodiments of the present invention. Both figures together show a flow diagram with the main path shown in bold font.

In FIG. 20 at 910, the method begins with a processor (e.g., processor 1020 of FIG. 22) using an access point receiver to scan signals from a plurality of APs. The plurality of APs may include no APs, APs not belonging to any LCI, or APs belonging to an LCI, The plurality of APs may include both APs not belonging to any LCI and APs belonging to one or more LCIs. In this case, at least one AP belongs to an LCI. At 920, a test is performed to determine whether at least one AP belongs to an LCI, which includes an indoor map. If no APs belong to an LCI, processing continues at continuation circle 3 described with reference to FIG. 21. If at least one AP belongs to an LCI, processing continues at 930. In various examples, the plurality of APs comprise: (1) only one AP belonging to a single LCI; (2) multiple APs only belonging to a single LCI; (3) APs belonging to a plurality of LCI, such as one or more APs belonging a first LCI and one or more APs belonging to a second LCI; (4) generally, one or more APs belonging one or more LCIs and one or more APs not belonging to any LCI.

At 930, the processor selects a first set of APs from the plurality of APs belonging to the LCI. The first set of APs may include one or more APs belonging to the LCI. At 940, the processor computes a position estimate based on the first set of APs. At 950, the processor determines whether the position estimate results in a position indoors (i.e., inside of the LCI map 120) or outdoors (i.e., outside of the LCI map 120). If indoors, processing continues at 970. If outdoors, processing continues at 960.

At 960, the processor performs a threshold test to determine whether the first set of APs comprise only weak APs or comprise at least one strong AP. An access point is considered a weak AP if, for example, its RSSI value is below a threshold level or its RTT value is beyond a threshold duration. If the first set comprises at least one strong AP, processing continues at 970. If the first set comprises only weak APs, processing continues at continuation circle 3 described with reference to FIG. 21. At 970, the processor displays an indoor map. In some embodiments, the processor also shows a position estimate and/or an uncertainty.

In FIG. 21, the method starts at 980 below continuation circle 3. At 980, the processor determines if GNSS signals are available. If GNSS signals are available, the method continues to 982. If not GNSS signals are available or insufficient GNSS signals are available, the method continues to 984. Alternative, if a mobile device 100 does not have a GNSS capability, continuation circle 3 leads to 984.

At 982, the processor or a position determination unit determines a position estimate of the mobile device 100 based on the GNSS signals. At 984, the processor or a position determination unit determines a position estimate of the mobile device 100 based on an urban LAN database 220. Inputs to the urban LAN database 220 may include all APs associated with one or more particular LCI, all LCI-associated APs, only non-LCI associated APs, or all AP regardless of LCI affiliation. An output from the urban LAN database 220 is a position estimate based on signals from the APs. The urban LAN database 220, sometime referred to as an urban LAN database 220, may be created form crowd sourcing AP and position information from a plurality of mobile devices and/or from one or more vehicles collecting AP and position information (e.g., a Google mapping van driving up and down streets in a neighborhood).

At 990, the processor using a display on the mobile device 100 to display an outdoor map with the position estimate of the mobile device 100 based on the first set of APs comprising only weak APs belonging to the LCI.

In sum, a first pass may include a first scanning, at 910, of signals from a first plurality of APs. During the first pass, it is determined, at 920, that at least one AP is associated with an LCI. A threshold test, at 960, reveals that only weak APs were found. Therefore, an outdoor map is displayed, at 990, possibly showing a position estimate and/or an uncertainty of the mobile device 100. A second, third and fourth pass are used below not to indication that multiple passes are made but to distinguish one paragraph from the next.

A second pass of the method of FIGS. 20 and 21 may include a second scanning of signals from a second plurality of APs. During the second pass, it may be determined that none of the second plurality of APs belongs to any LCI. In this case, a display may show a second outdoor map based on the second plurality of APs not belonging to any LCI. The second outdoor map may display a second position estimate of the mobile device 100 computed from GNSS signals or an urban LAN database 220.

A third pass of the method of FIGS. 20 and 21 may include a third scanning of signals from a third plurality of APs. During the third pass, it may be determined that the third plurality of APs do not belong to any LCI. In this case, a display may show a third outdoor map based on the third plurality of APs not belonging to any LCI. The display may show the third outdoor map displaying a third position estimate computed based on GNSS signals. The third outdoor map may comprise a third position estimate computed based on an urban LAN database 220.

A fourth pass of the method of FIGS. 20 and 21 may include a fourth scan scanning signals from a fourth plurality of APs. During the fourth pass, it may be determined that at least one of the fourth plurality of APs belongs to a fourth LCI. A fourth position estimate may be determine to be indoors (i.e., inside the LCI map 120). The fourth indoor map is based on the fourth plurality of APs belonging to the fourth LCI and the fourth position estimate being indoors.

FIG. 22 shows a mobile device 100, in accordance with some embodiments of the present invention. The mobile device 100 includes a transceiver 1010, a processor 1020, a position determination unit 1030 and a display 1040. The transceiver 1010 may include a WiFi receiver coupled to the processor 1020. The transceiver 1010 provides either scanning signals or a scan list of available APs. The position determination unit 1030 is coupled to the processor 1020 and may be a GNSS receiver (e.g., GPS receiver).

The processor 1020 includes various software modules including a selection unit 1022, a comparator 1024 and a map decider unit 1026. The selection unit 1022 is coupled to the transceiver 1010 to receive a plurality of scanned APs and determines if an AP is found that belongs to an LCI or not. A signal goes to the map decider unit 1026 to indicate when no AP is found that belongs to an LCI. If one or more APs are found, a signal is provided to the comparator 1024 indicating that AP(s) belong to one or more LCIs.

The comparator 1024 compares the signal to a threshold. For example, if the signal represents an RSSI value, the comparator compares the RSSI value to the threshold. If the signal is below the threshold, the AP is considered a weak AP, and otherwise, the AP is considered a strong AP. If the signal represents an RTT value, the comparator compares the RTT value to the threshold. If the signal is above the threshold, the AP is considered a weak AP, and otherwise, the AP is considered a strong AP. An indication of whether all one or more APs are weak or whether at least one of the one or more APs are strong is provided to the map decider unit 1026.

The map decider unit 1026 directs the display 1040 to display either an indoor map or an outdoor map based on the signals from the comparator 1024, the selection unit 1022 and the position determination unit 130. The map decider unit 1026 may instruct the display 1040 with a selected indoor or outdoor map along with the position estimate and/or uncertainty of the mobile device 100.

FIG. 23 shows a table illustrating whether an indoor map or an outdoor map is displayed, in accordance with some embodiments of the present invention. First, an LCI test is performed. If no AP is out that is associated with an LCI, an outdoor map is displayed, as shown be the first check mark. If an LCI is found, the process continues. Next, an indoor/outdoor test is performed. If the mobile device 100 is determine to be indoors, an indoor map associated with the LCI is displayed, as shown be the second check mark. If the mobile device 100 is determine to be outdoors, a strong/weak test is performed. If at least one AP is determined to be strong, an indoor map may be used, as shown be the third check mark. If all APs are weak, prior art systems would have shown an indoor map, as shown be the ‘x’ mark. Embodiments described herein, display an outdoor map if all APs are weak, as shown be the fourth check mark.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor 1020. Memory may be implemented within the processor 1020 or external to the processor 1020. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method in a mobile device for determining a map to be used based on local area network (LAN) signals from access points (APs), the method comprising:
scanning LAN signals from a plurality of APs, wherein the plurality of APs comprise a first set of APs belonging to a location context identifier (LCI) wherein the LCI comprises an indoor map;
selecting the first set of APs from the plurality of APs belonging to the LCI;
performing a threshold test to determine that the first set of APs comprises only APs beyond a threshold; and
displaying an outdoor map with a position estimate of the mobile device based on the first set of APs comprising only APs beyond the threshold belonging to the LCI.

2. The method of claim 1, wherein the plurality of APs further comprise APs not belonging to any LCI.

3. The method of claim 1, wherein the plurality of APs further comprise APs belonging to a second LCI.

4. The method of claim 1, wherein the first set of APs comprises a single AP.

5. The method of claim 1, wherein the APs beyond the threshold comprises APs having received signal strength indicator (RSSI) values below the threshold.

6. The method of claim 1, wherein the APs beyond the threshold comprises APs having round-trip time (RTT) values above the threshold.

7. The method of claim 1, further comprising determining the position estimate is positioned outside of the indoor map.

8. The method of claim 1, wherein the position estimate is based on global navigation satellite system (GNSS) signals.

9. The method of claim 1, wherein the position estimate is based on a LAN database using the LAN signals from the plurality of APs.

10. The method of claim 1, further comprising:
scanning LAN signals from a third plurality of APs;
determining the third plurality of APs do not belong to any LCI;
displaying a third outdoor map based on the third plurality of APs not belonging to any LCI.

11. The method of claim 10, wherein displaying the third outdoor map comprises displaying a third position estimate, the method further comprising computing the third position estimate based on global navigation satellite system (GNSS) signals.

12. The method of claim 10, wherein displaying the third outdoor map comprises displaying a third position estimate, the method further comprising computing the third position estimate based on a LAN database.

13. The method of claim 1, further comprising:
scanning LAN signals from a fourth plurality of APs;
determining at least one of the fourth plurality of APs belongs to a fourth LCI wherein the fourth LCI comprises a fourth indoor map;
determining a fourth position estimate is indoors; and
displaying the fourth indoor map based on the fourth plurality of APs belonging the fourth LCI and the fourth position estimate being indoors.

14. A mobile device for determining a map to be used based on local area network (LAN) signals from access points (APs), the mobile device comprising:
a transceiver configured to scan LAN signals from a plurality of APs, wherein the plurality of APs comprise a first set of APs belonging to a location context identifier (LCI) wherein the LCI comprises an indoor map;
a selection unit coupled to the transceiver, the selection unit configured to select the first set of APs from the plurality of APs belonging to the LCI;
a comparator coupled to the selection unit and a threshold, the comparator configured to determine the first set of APs comprises only APs beyond a threshold; and
a display coupled to the comparator, the indoor map and an outdoor map, the display configured to display the outdoor map with a position estimate of the mobile device based on the first set of APs comprising only APs beyond the threshold belonging to the LCI.

15. The mobile device of claim 14, wherein the plurality of APs further comprise APs not belonging to any LCI.

16. The mobile device of claim 14, wherein the plurality of APs further comprise APs belonging to a second LCI.

17. The mobile device of claim 14, further comprising a position determination unit configured to determining the position estimate is positioned outside of the indoor map.

18. A mobile device for determining a map to be used based on local area network (LAN) signals from access points (APs), the mobile device comprising:
means for scanning LAN signals from a plurality of APs, wherein the plurality of APs comprise a first set of APs belonging to a location context identifier (LCI) wherein the LCI comprises an indoor map;
means for selecting the first set of APs from the plurality of APs belonging to the LCI;
means for performing a threshold test to determine that the first set of APs comprises only APs beyond a threshold; and
means for displaying an outdoor map with a position estimate of the mobile device based on the first set of APs comprising only APs beyond the threshold belonging to the LCI.

19. The mobile device of claim 18, wherein the plurality of APs further comprise APs not belonging to any LCI.

20. The mobile device of claim 18, wherein the plurality of APs further comprise APs belonging to a second LCI.

21. The mobile device of claim 18, further comprising a position determination unit configured to determining the position estimate is positioned outside of the indoor map.

22. The mobile device of claim 18, further comprising:
means for scanning LAN signals from a third plurality of APs;
means for determining the third plurality of APs do not belong to any LCI;
means for displaying a third outdoor map based on the third plurality of APs not belonging to any LCI.

23. The mobile device of claim 22, wherein the means for displaying the third outdoor map comprises means for displaying a third position estimate, the mobile device further comprising means for computing the third position estimate based on global navigation satellite system (GNSS) signals.

24. The mobile device of claim 22, wherein the means for displaying the third outdoor map comprises means for displaying a third position estimate, the mobile device further comprising means for computing the third position estimate based on a LAN database.

25. A mobile device comprising a processor and a memory for determining a map to be used based on local area network (LAN) signals from access points (APs) wherein the memory includes software instructions for:
scanning LAN signals from a plurality of APs, wherein the plurality of APs comprise a first set of APs belonging to a location context identifier (LCI) wherein the LCI comprises an indoor map;
selecting the first set of APs from the plurality of APs belonging to the LCI;
performing a threshold test to determine that the first set of APs comprises only APs beyond a threshold; and
displaying an outdoor map with a position estimate of the mobile device based on the first set of APs comprising only APs beyond the threshold belonging to the LCI.

26. The mobile device of claim 25, further comprising software instructions for:
scanning LAN signals from a third plurality of APs;
determining the third plurality of APs do not belong to any LCI;
displaying a third outdoor map based on the third plurality of APs not belonging to any LCI.

27. The mobile device of claim 26, wherein the software instructions for displaying the third outdoor map comprises software instructions for displaying a third position estimate, the mobile device further comprising software instructions for computing the third position estimate based on global navigation satellite system (GNSS) signals.

28. The mobile device of claim 26, wherein the software instructions for displaying the third outdoor map comprises displaying a third position estimate, the mobile device further comprising software instructions for computing the third position estimate based on a LAN database.

29. A non-volatile computer-readable storage medium including program code stored thereon, comprising program code for:
scanning, by a mobile device, local area network (LAN) signals from a plurality of APs, wherein the plurality of APs comprise a first set of APs belonging to a location context identifier (LCI) wherein the LCI comprises an indoor map;
selecting the first set of APs from the plurality of APs belonging to the LCI;
performing a threshold test to determine that the first set of APs comprises only APs beyond a threshold; and
displaying an outdoor map with a position estimate of the mobile device based on the first set of APs comprising only APs beyond the threshold belonging to the LCI.

30. The non-volatile computer-readable storage medium of claim 29, further comprising program code for:
scanning LAN signals from a third plurality of APs;
determining the third plurality of APs do not belong to any LCI;
displaying a third outdoor map based on the third plurality of APs not belonging to any LCI.

31. The non-volatile computer-readable storage medium of claim 30, wherein the program code for displaying the third outdoor map comprises program code for displaying a third position estimate, the non-volatile computer-readable storage medium further comprising program code for computing the third position estimate based on global navigation satellite system (GNSS) signals.

32. The non-volatile computer-readable storage medium of claim 30, wherein the program code for displaying the third outdoor map comprises program code for displaying a third position estimate, the non-volatile computer-readable storage medium further comprising program code for computing the third position estimate based on a LAN database.
